(19) United States
(12) Patent Application Publication
(10) Pub. No.: US 2026/0321814 A1
(43) Pub. Date: Oct. 15, 2026

(54) BATTERY CELL

(71) Applicant: TOYOTA JIDOSHA KABUSHIKI KAISHA, Toyota-shi Aichi-ken (JP)

(72) Inventor: Kazuma ASAKURA, Okazaki-shi Aichi-ken (JP)

(73) Assignee: TOYOTA JIDOSHA KABUSHIKI KAISHA, Toyota-shi Aichi-ken (JP)

(21) Appl. No.: 19/574,566

(22) Filed: Mar. 23, 2026

(30) Foreign Application Priority Data
Apr. 9, 2025 (JP) 2025-064581

(51) Int. Cl. H01M 50/124; H01M 10/613; H01M 10/647; H01M 50/103; H01M 50/15

(52) U.S. Cl. CPC H01M 50/1245; H01M 10/613; H01M 10/647; H01M 50/103; H01M 50/15

(57) ABSTRACT

A battery cell includes: a rectangular outer casing configured to house an electrode body; an insulating film covering surfaces of the outer casing other than a lid portion of the outer casing; an overlapping portion where edges of the insulating film are overlapped on one of the surfaces of the outer casing other than the lid portion; and a heat-conducting member configured to seal the overlapping portion by contacting the overlapping portion.

### CROSS-REFERENCE TO RELATED APPLICATIONS

The present application claims priority to and incorporates by reference the entire contents of Japanese Patent Application No. 2025-064581 filed in Japan on April 9, 2025.

### BACKGROUND

The present disclosure relates to a battery cell.

JP2013033668A discloses a battery cell covered by laminating an insulating film onto the side surface of an outer can, among other surfaces.

### SUMMARY

If only an insulating film is laminated onto the outer can, as disclosed in JP2013033668A, there is a risk that condensation water may infiltrate through the overlapping portions of the insulating film when the battery cell is installed as a battery pack in a vehicle, leading to a decrease in insulation performance.

There is a need for a battery cell that is able to prevent condensation water from infiltrating through the overlapping portions of the insulating film and thereby suppress the deterioration of insulation properties.

According to one aspect of the present disclosure, there is provided a battery cell including: a rectangular outer casing configured to house an electrode body; an insulating film covering surfaces of the outer casing other than a lid portion of the outer casing; an overlapping portion where edges of the insulating film are overlapped on one of the surfaces of the outer casing other than the lid portion; and a heat-conducting member configured to seal the overlapping portion by contacting the overlapping portion.

### BRIEF DESCRIPTION OF THE DRAWINGS

FIG. 1 is a diagram showing the outer casing and insulating film provided by the battery cell according to an embodiment;

FIG. 2 is a diagram showing step 2 of the covering process for covering the outer casing with the insulating film;

FIG. 3 is a diagram showing step 3 of the covering process for covering the outer casing with the insulating film;

FIG. 4 is a diagram showing step 4 of the covering process for covering the outer casing with the insulating film;

FIG. 5 is a diagram showing step 5 of the covering process for covering the outer casing with the insulating film;

FIG. 6 is a diagram showing a state where the overlapping portion of the insulating film is sealed by blocking it with a heat-conducting member.

FIG. 7 is a diagram showing a case where the outer casing is coated using two insulating films; and

FIG. 8 is a diagram showing a state where overlapping portions are formed on the upper surface and lower surface of the outer casing.

### DETAILED DESCRIPTION

The following describes an embodiment of a battery cell according to the present disclosure. Note that the present disclosure is not limited to the embodiment.

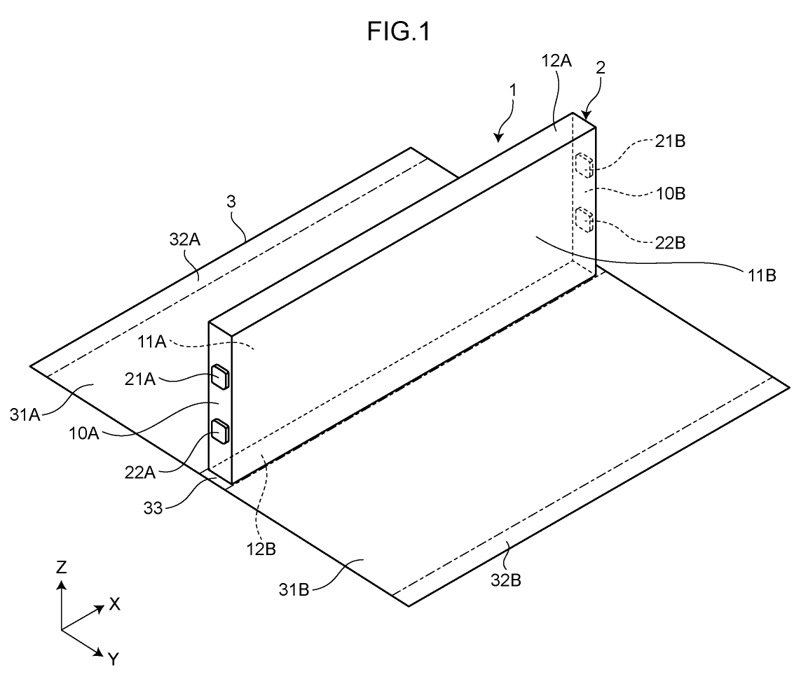

FIG. 1 is a diagram showing the outer casing 2 and insulating film 3 provided by the battery cell 1 according to the embodiment. Note that FIG. 1 also illustrates step 1 of the coating process described later, wherein the outer casing 2 is coated with the insulating film 3.

As illustrated in FIG. 1, the battery cell 1 according to the embodiment includes a rectangular outer casing 2 for housing an electrode body (not illustrated) and an insulating film 3 covering the outer casing 2.

In FIG. 1, “X” represents the width direction of the battery cell 1 and is also referred to simply as the “width direction X” in the following description. “Y” represents the thickness direction of the battery cell 1 and is also referred to simply as the “thickness direction Y” in the following description. “Z” represents the height direction of the battery cell 1 and is also referred to simply as the “height direction Z” in the following description.

The width direction X of the battery cell 1 in FIG. 1 is in the same direction as the width direction of the outer casing 2 and the short direction of the insulating film 3. The thickness direction Y of the battery cell 1 in FIG. 1 is in the same direction as the thickness direction of the outer casing 2 and the long direction of the insulating film 3. The height direction Z of the battery cell 1 in FIG. 1 is in the same direction as the height direction of the outer casing 2.

The outer casing 2 has a first end face portion 10A, a second end face portion 10B, a first side face portion 11A, a second side face portion 11B, an upper face portion 12A, and a lower face portion 12B. Two electrical terminals 21A and 22A are provided on the first end face portion 10A. Additionally, two electrical terminals 21B and 22B are provided on the second end face portion 10B.

The first end face portion 10A and the second end face portion 10B are cover portions configured to be detachable from the main body portion of the outer casing 2. When accommodating an electrode body or the like within the outer casing 2, the first end face portion 10A and the second end face portion 10B are removed from the main body portion of the outer casing 2. The main body portion of the casing 2 is formed by a first side portion 11A, a second side portion 11B, a top portion 12A, and a bottom portion 12B.

In the battery cell 1 according to the embodiment, the first end face portion 10A, which is at one end in the width direction (width direction X) of the outer casing 2 and has the electrode terminals 21A, 22A provided thereon, and the second end face portion 10B, which is at the other end in the width direction X and has the electrode terminals 21B, 22B provided thereon, serve as the lid portion of the outer casing 2. This configuration allows for improved structural efficiency.

As illustrated in FIG. 1, the insulating film 3 has a first upper surface covering portion 32A, a first side surface covering portion 31A, a lower surface covering portion 33, a second side surface covering portion 31B, and a second upper surface covering portion 32B extending from one end side to the other end side in the longitudinal direction (thickness direction Y) of the insulating film 3. The dotted lines illustrated on the insulating film 3 indicate fold lines when bending the insulating film 3 and also represent the boundaries between adjacent coating sections.

Furthermore, at least one surface of the insulating film 3, specifically the surface capable of contacting the outer casing 2, has an adhesive layer for bonding to the outer casing 2. This adhesive layer is formed, for example, by applying an adhesive.

The battery cell 1 according to the embodiment is manufactured by covering surfaces other than the first end face portion 10A and the second end face portion 10B, which are the lid portions of the outer casing 2, with the insulating film 3, through the following steps 1 to 5 described using FIGS. 1 to 5, for example. Furthermore, in the battery cell 1 according to the embodiment, the top surface portion 12A, which is at least one surface portion excluding the first end surface portion 10A and the second end surface portion 10B of the outer casing 2, is sealed by overlapping the first top surface covering portion 32A and the second top surface covering portion 32B of the insulating film 3.

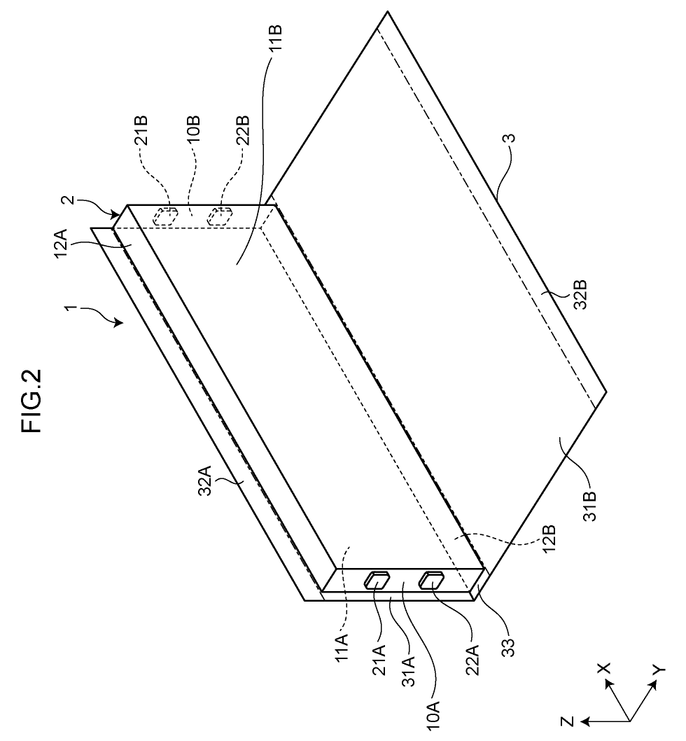

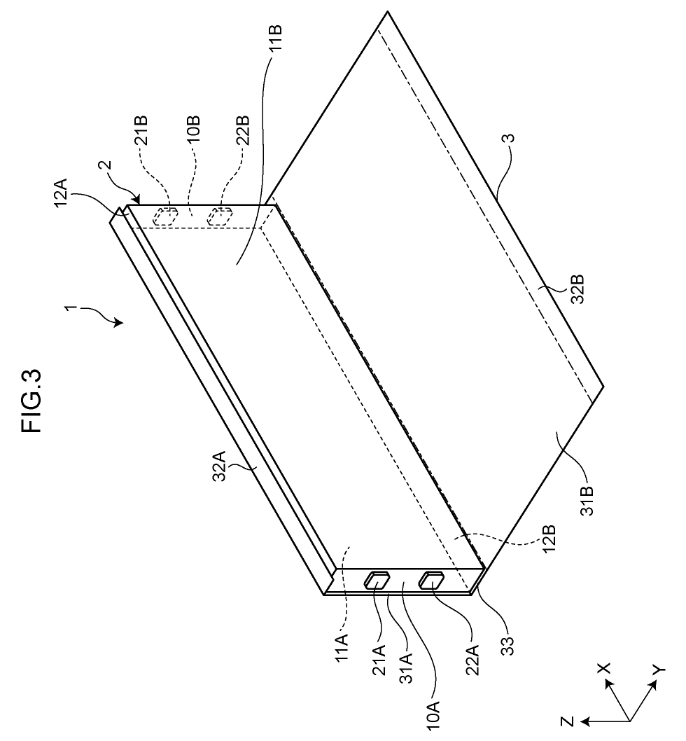

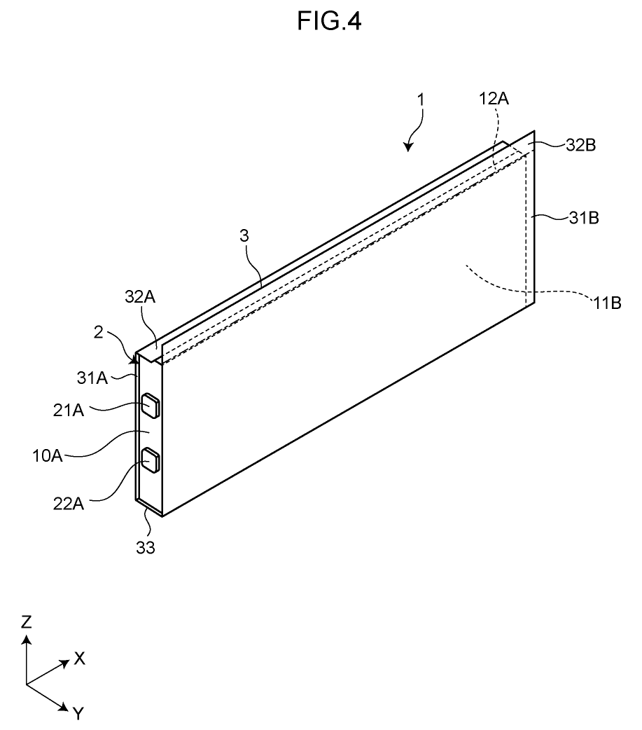

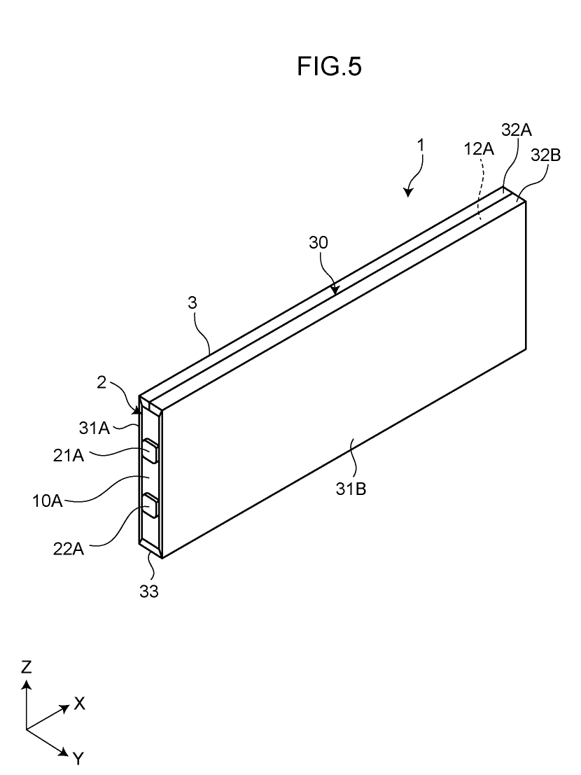

Next, steps 1 to 5 of the covering process for covering the outer casing 2 with the insulating film 3 in the battery cell 1 according to the embodiment are described using FIGS. 1 to 5. FIG. 2 is a diagram showing step 2 of the covering process for covering the outer casing 2 with the insulating film 3. FIG. 3 is a diagram showing step 3 of the covering process for covering the outer casing 2 with the insulating film 3. FIG. 4 is a diagram showing step 4 of the covering process for covering the outer casing 2 with the insulating film 3. FIG. 5 is a diagram showing step 5 of the covering process for covering the outer casing 2 with the insulating film 3.

First, in step 1, as illustrated in FIG. 1, the bottom surface portion 12B of the outer casing 2 is placed on top of the bottom surface covering portion 33 of the insulating film 3.

Next, in step 2, as illustrated in FIG. 2, the insulating film 3 is folded so that the first side covering portion 31A of the insulating film 3 covers the first side portion 11A of the outer casing 2, and the first side covering portion 31A is adhered to the first side portion 11A.

Next, in step 3, as illustrated in FIG. 3, the insulating film 3 is folded so that the first top surface covering portion 32A of the insulating film 3 covers a portion of the top surface portion 12A of the outer casing 2, and the first top surface covering portion 32A is adhered to the top surface portion 12A.

Next, in step 4, as illustrated in FIG. 4, the insulating film 3 is folded so that the second side covering portion 31B of the insulating film 3 covers the second side portion 11B of the outer casing 2, and the second side covering portion 31B is adhered to the second side portion 11B.

Next, in step 5, as illustrated in FIG. 5, the insulating film 3 is folded such that the second top surface covering portion 32B covers a portion of both the top surface portion 12A of the outer casing 2 and a portion of the first top surface covering portion 32A of the insulating film 3. The second top surface covering portion 32B is then overlapped onto the first top surface covering portion 32A and adhered to both the top surface portion 12A and the first top surface covering portion 32A. As a result, the battery cell 1 according to the embodiment has surfaces of the outer casing 2, excluding the first end face portion 10A and the second end face portion 10B, covered by the insulating film 3.

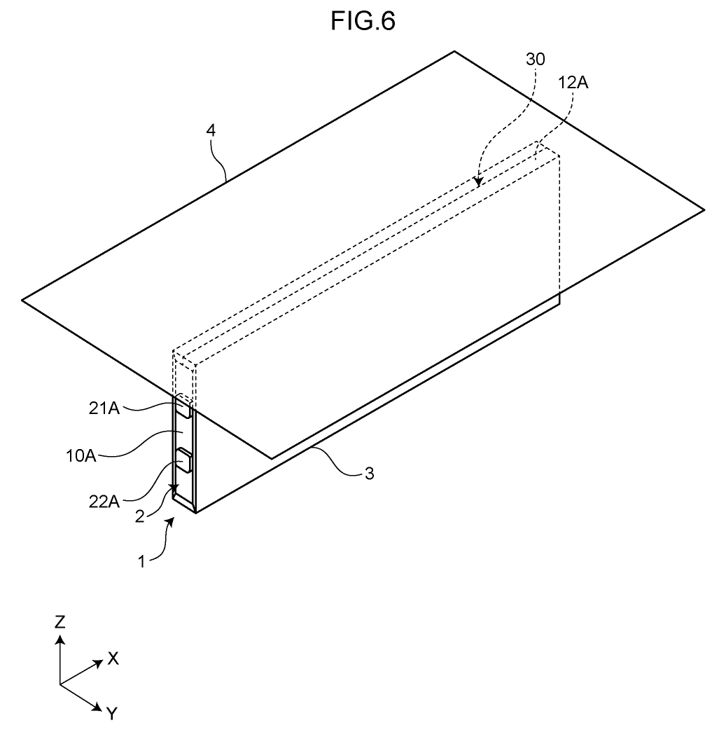

FIG. 6 is a diagram showing the state where the overlapping portion 30 of the insulating film 3 is blocked and sealed by the heat-conducting member 4.

In the battery cell 1, the overlapping portion 30 between the first top covering portion 32A and the second top covering portion 32B of the insulating film 3 is sealed by either contacting and blocking it with the planar portion of the heat-conducting member 4, as illustrated in FIG. 6, or by bonding it with an adhesive when multiple battery cells 1 are stacked to form a battery pack.

It is also desirable, for example, to utilize the overlapping portion 30 of the insulating film 3 as a cooling surface of the battery cell 1 and to seal it by covering the overlapping portion 30 with the flat surface of a cooler acting as the heat-conducting member 4 in contact with it. This allows the cooler (heat conduction member 4) to be shared for both sealing the overlap portion 30 and cooling the battery cell 1. Consequently, it reduces the number of parts, saves space, and improves structural efficiency.

In the battery cell 1 according to the embodiment, sealing the overlapping portion 30 of the insulating film 3 with the heat-conducting member 4 prevents condensation water from entering through the overlapping portion 30, thereby suppressing a decrease in insulation properties.

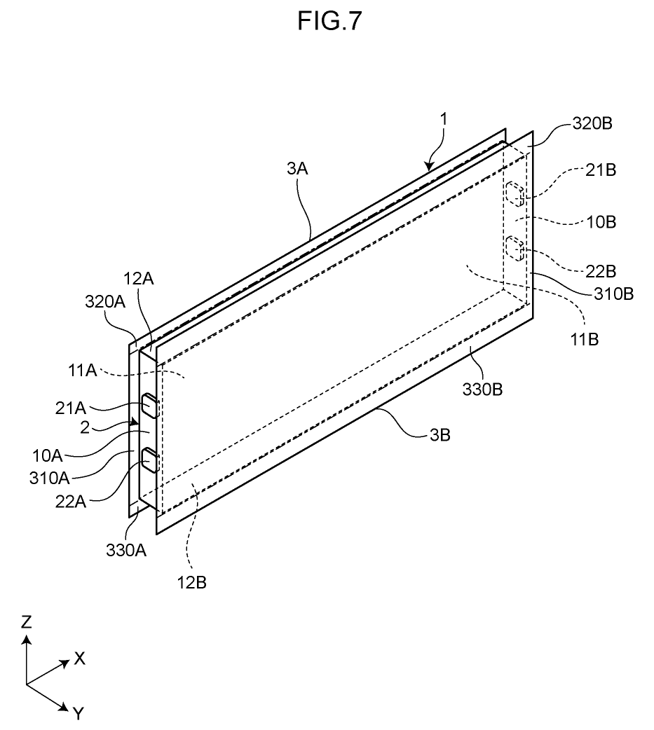

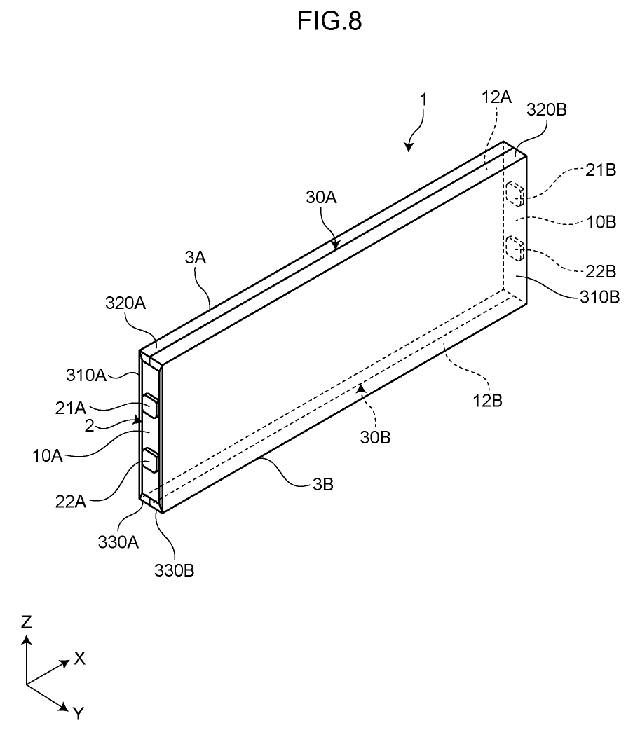

FIG. 7 is a diagram showing a case where the outer casing 2 is covered using two insulating films 3A and 3B. FIG. 8 is a diagram showing the state where overlapping portions 30A and 30B are formed on the upper surface portion 12A and lower surface portion 12B of the outer casing 2.

In the battery cell 1 according to the embodiment, as illustrated in FIG. 7, the outer casing 2 may be configured to be covered by two insulating films 3A and 3B. As illustrated in FIG. 7, the insulating film 3A has a first top surface covering portion 320A, a first side surface covering portion 310A, and a first bottom surface covering portion 330A extending from one end to the other end in the short-hand direction (height direction Z) of the insulating film 3A.

Furthermore, as illustrated in FIG. 7, the insulating film 3B has, in the short-hand direction (height direction Z) of the insulating film 3B from one end to the other end, a second top surface covering portion 320B, a second side surface covering portion 310B, and a second bottom surface covering portion 330B.

Then, as illustrated in FIG. 7, the first side covering portion 310A of the insulating film 3A is adhered to the first side portion 11A of the outer casing 2, and the second side covering portion 310B of the insulating film 3B is adhered to the second side portion 11B of the outer casing 2.

Next, as illustrated in FIG. 8, the insulating film 3A is folded so that the first top surface covering portion 320A of the insulating film 3A covers a portion of the top surface portion 12A of the outer casing 2, and the first top surface covering portion 320A is adhered to the top surface portion 12A. After that, the second top surface covering portion 320B of the insulating film 3B is folded such that it covers a portion of both the top surface portion 12A of the outer casing 2 and the first top surface covering portion 320A of the insulating film 3A. overlapping the second top covering portion 320B onto the first top covering portion 320A and adhering it to the top surface 12A and the first top covering portion 320A. This forms an overlapping portion 30A on the top surface 12A of the outer casing 2, where the first top covering portion 320A and the second top covering portion 320B are overlapped.

Furthermore, as illustrated in FIG. 8, the first bottom covering portion 330A of the insulating film 3A is bent such that it covers a portion of the bottom surface 12B of the outer casing 2, and the first bottom covering portion 330A is adhered to the bottom surface 12B. Subsequently, the second bottom covering portion 330B of the insulating film 3B is folded such that it covers a portion of both the bottom portion 12B of the outer casing 2 and the first bottom covering portion 330A of the insulating film 3A. overlapping the second bottom covering portion 330B onto the first bottom covering portion 330A and adhering it to the bottom portion 12B and the first bottom covering portion 330A. This forms an overlapping portion 30B on the bottom portion 12B of the outer casing 2, where the first bottom covering portion 330A and the second bottom covering portion 330B are overlapped.

Furthermore, the overlapping portion 30A formed on the upper surface portion 12A of the outer casing 2 and the overlapping portion 30B formed on the lower surface portion 12B of the outer casing 2 are each sealed by contacting and sealing them against the flat surface of a heat conduction member such as a cooler, or by bonding them with an adhesive. This prevents condensation water from entering through the overlapping sections 30A and 30B formed at two locations—the upper surface section 12A and the lower surface section 12B—of the outer casing 2, thereby suppressing a decrease in insulation properties.

The battery cell of the present disclosure achieves the effect of sealing the overlapping portion of the insulating film with a heat-conducting member, preventing condensation water ingress, and suppressing deterioration of insulation properties.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery cell comprising:
a rectangular outer casing configured to house an electrode body;
an insulating film covering surfaces of the outer casing other than a lid portion of the outer casing;
an overlapping portion where edges of the insulating film are overlapped on one of the surfaces of the outer casing other than the lid portion; and
a heat-conducting member configured to seal the overlapping portion by contacting the overlapping portion.

2. The battery cell according to claim 1, wherein the lid portion is both end faces in a width direction of the battery cell.

3. The battery cell according to claim 1, wherein the heat-conducting member is a cooler.

4. The battery cell according to claim 2, wherein the heat-conducting member is a cooler.
